(19) United States
(12) Patent Application Publication
(10) Pub. No.: US 2026/0270790 A1
(43) Pub. Date: Sep. 10, 2026

(54) DYNAMIC BANDWIDTH EXPANSION AND BANDWIDTH RESET

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US)

(21) Appl. No.: 19/555,490

(22) Filed: Mar. 3, 2026

Related U.S. Application Data
(60) Provisional application No. 63/766,880, filed on Mar. 4, 2025.

(51) Int. Cl. H04W 28/16

(52) U.S. Cl. CPC H04W 28/16

(57) ABSTRACT

Described herein is a wireless access point that signals when the access point changes bandwidth. The wireless access point includes one or more memories and one or more processors communicatively coupled to the one or more memories. The one or more processors, individually or collectively, perform an operation that includes based on determining that a bandwidth of a channel should be expanded to an expanded bandwidth, determining (i) a first time when the wireless access point will begin expanding the bandwidth and (ii) an amount of time the wireless access point will use to expand the bandwidth starting at the first time, transmitting, before the first time, a first message indicating the first time, transmitting, before the first time, a second message indicating the amount of time, and at the first time, expanding the bandwidth of the channel.

### CROSS-REFERENCE TO RELATED APPLICATIONS

This application claims benefit of co-pending U.S. provisional patent application Ser. No. 63/766,880 filed Mar. 4, 2025. The aforementioned related patent applications are herein incorporated by reference in their entirety

### TECHNICAL FIELD

Embodiments presented in this disclosure generally relate to wireless networks. More specifically, embodiments disclosed herein relate to expanding bandwidth of a channel in a wireless network.

### BACKGROUND

In a wireless network, the available channel bandwidth (or spectrum) may be split across the access points in the network to reduce channel overlap and interference. Splitting the channel bandwidth limits the amount of bandwidth each access point may use. On occasion, there may be a need to expand the bandwidth available to an access point. For example, the bandwidth available to an access point may be expanded to support more throughput for certain applications (e.g., virtual reality or videoconference). When the demand for the bandwidth reduces, the bandwidth may be reset or lowered.

In existing networks, when an access point changes bandwidth (e.g., bandwidth expansions or reductions), the access point may become temporarily unavailable (e.g., due to the access point changing (or retuning) its center frequency for operating with the updated bandwidth). During this time, if a device transmits a message to the access point, the access point may not receive the message. The device may perceive this unresponsiveness as access point instability and connect to a different access point. To reduce the likelihood of being considered unresponsive, the access point may change bandwidth infrequently (e.g., once per day). Furthermore, if the extended channel switch announcement (ECSA) mechanism is used by the access point to announce a change in the bandwidth, then some devices may respond by roaming away from the access point to avoid connectivity disruptions due to bandwidth change.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIGS. 5A and 5B illustrate an example message in the system of FIG. 1A.

FIGS. 6A and 6B illustrate an example message in the system of FIG. 1A.

FIG. 7 is a flowchart of an example method performed by the system of FIG. 1A.

FIG. 8 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point that signals when the access point changes bandwidth. According to an embodiment, a wireless access point includes one or more memories and one or more processors communicatively coupled to the one or more memories. The one or more processors, individually or collectively, perform an operation that includes based on determining that a bandwidth of a channel should be expanded to an expanded bandwidth, determining (i) a first time when the wireless access point will begin expanding the bandwidth and (ii) an amount of time the wireless access point will use to expand the bandwidth starting at the first time, transmitting, before the first time, a first message indicating the first time, transmitting, before the first time, a second message indicating the amount of time, and at the first time, expanding the bandwidth of the channel.

According to another embodiment, a method includes based on determining that a bandwidth of a channel should be expanded to an expanded bandwidth, determining, by a wireless access point, (i) a first time when the wireless access point will begin expanding the bandwidth and (ii) an amount of time the wireless access point will use to expand the bandwidth starting at the first time, transmitting, by the wireless access point and before the first time, a first message indicating the first time, transmitting, by the wireless access point and before the first time, a second message indicating the amount of time, and at the first time, expanding the bandwidth of the channel.

According to another embodiment, a device includes one or more memories and one or more processors communicatively coupled to the one or more memories. The one or more processors, individually or collectively, perform an operation that includes receiving, from a wireless access point, a first message indicating a first time when the wireless access point will begin expanding a bandwidth of a channel to an expanded bandwidth, receiving, from the wireless access point, a second message indicating an amount of time the wireless access point will use to expand the bandwidth starting at the first time, and at the first time, refrain from transmitting a message to the wireless access point for the amount of time.

### EXAMPLE EMBODIMENTS

The present disclosure describes an access point that signals when the access point changes bandwidth. For example, when the access point determines that bandwidth should be expanded at a future time, the access point may transmit a message to connected devices (which may also be referred to as client devices, clients, stations (STAs), or non-access point multi-link devices (non-AP MLDs)) indicating the future time when the bandwidth expansion will happen. The access point may indicate an amount of time that the access point will be unavailable when performing the bandwidth expansion. When the access point completes expanding the bandwidth, the access point may notify the devices that the bandwidth expansion is complete. As another example, when the access point determines that the expanded bandwidth should be reset or reduced (e.g., to the original basic service set (BSS) bandwidth) at another future time, the access point may transmit a message to the connected devices indicating the future time. In this case, the access point may indicate an amount of time that the access point will be unavailable when performing the bandwidth change. In this manner, the devices may be notified of when the access point will be updating the bandwidth and may be unavailable due to bandwidth changes, and then devices may avoid transmitting messages to the access point during those times.

In certain embodiments, the access point provides several technical advantages. For example, the access point may allow bandwidth to be expanded and reduced while avoiding or minimizing unsuccessful transmissions from the client devices to the access point. As another example, the access point may improve stability of the network by signaling when bandwidth changes occur so that connected devices do not misinterpret a change in bandwidth as network instability with the access point. As another example, the access point may minimize or reduce access point unavailability for devices when bandwidth changes happen by notifying the devices when the bandwidth change has completed, so that the devices can resume connectivity to the network as soon as possible.

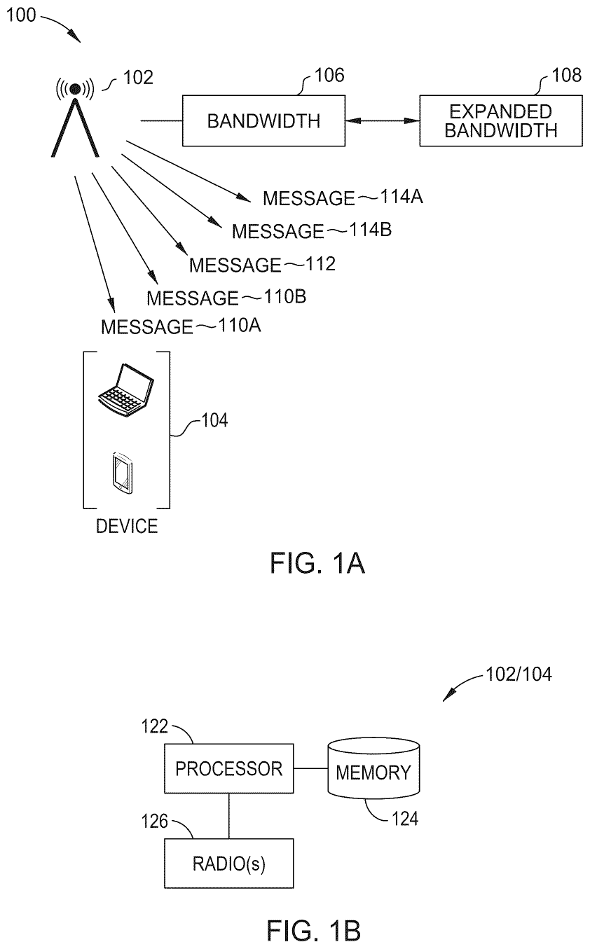

FIG. 1A illustrates an example system 100. As seen in FIG. 1A, the system 100 includes an access point 102 and a device 104. The system 100 may include multiple devices 104 connected to the access point 102. Generally, the access point 102 communicates messages indicating a time when the access point 102 will perform bandwidth expansion and an amount of time that it will take for the access point 102 to expand the bandwidth. In this manner, the device 104 may avoid communicating messages to the access point 102 during the time when the access point 102 is expanding bandwidth.

The access point 102 may be a network device that facilitates wireless communication (e.g., Wi-Fi communication) in the system 100. The device 104 connects to the access point 102, and the access point 102 may facilitate communication to and from the device 104. For example, the access point 102 may receive messages from the device 104 and direct those messages towards their destination. As another example, the access point 102 may receive messages intended for the device 104 and direct those messages to the device 104.

The device 104 is any suitable device for communicating with components of the system 100. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment. The device 104 may include a hardware processor, memory, or circuitry configured to perform any of the functions or actions of the device 104 described herein. For example, a software application designed using software code may be stored in the memory and executed by the processor to perform the functions of the device 104.

The access point 102 may use a bandwidth 106 to communicate with the device 104 (and other devices). The bandwidth 106 may limit the data capacity through the access point 102. In some instances, the amount of bandwidth 106 allotted to the access point 102 may be insufficient to handle all the traffic through the access point 102 for one or more devices 104. For example, when the one or more devices 104 are using a virtual reality application, a videoconferencing application, or another high throughput application, the amount of traffic handled by the access point 102 may increase significantly. Because the data capacity of the access point 102 is limited by the bandwidth 106, the access point 102 may not handle all of that traffic as quickly as needed to meet the quality of service (QoS) requirements for these applications (some of which may be latency sensitive applications). As a result, the quality of the virtual reality, videoconferencing, or other applications may degrade.

In some instances, the access point 102 may determine to expand the bandwidth 106 used by the access point 102. For example, the access point 102 may expand the bandwidth 106 to an expanded bandwidth 108, which may increase the data capacity of the access point 102. As a result, the access point 102 may be able to handle more amount of traffic faster. After the amount of traffic reduces (e.g., because the device 104 stops using the virtual reality, videoconferencing application, or other high throughput application), the access point 102 may reduce or reset the expanded bandwidth 108 back to the bandwidth 106. In this manner, the access point 102 may dynamically adjust the bandwidth 106 as needed.

The access point 102, however, becomes unavailable for some time when expanding or reducing bandwidth (e.g., due to the access point changing (or retuning) its center frequency for operating with the updated bandwidth). As a result, the access point 102 does not receive or transmit messages during the time the access point 102 is adjusting the bandwidth. If the device 104 transmits a message to the access point 102 during that time, the access point 102 may not respond to the device 104, which may lead the device 104 to determine that the access point 102 is unresponsive, and the device 104 may take actions such as looking for another access point or reducing its modulation and coding (MCS) rate used with the access point 102. These actions may cause connectivity disruptions or reduce throughput for the device 104, both of which are undesirable.

To avoid such scenarios, the access point 102 may signal when the access point 102 will be adjusting the bandwidth (e.g., expanding or reducing bandwidth) by signaling the time when the bandwidth change (expansion or reduction) will happen. For instance, the access point 102 may signal (e.g., in a beacon, probe response, (re)association response, etc.) a time (e.g., in number of Target Beacon Transmission Times (TBTTs), number of beacon intervals, or in timing synchronization function (TSF) time) when the bandwidth change will happen. The access point 102 may also signal the amount of time that the access point 102 will take to adjust the bandwidth. As seen in FIG. 1A, when the access point 102 determines that the access point 102 should expand the bandwidth 106, the access point 102 communicates (e.g., in a beacon, probe response, etc.) a message 110A indicating a future time when the access point 102 will expand the bandwidth 106 (to expanded bandwidth 108). The access point 102 may also communicate (e.g., in a beacon, probe response, etc.) a message 110B that indicates an amount of time it will take for the access point 102 to expand the bandwidth 106 to the expanded bandwidth 108. The messages 110A and 110B may be communicated in the same frame (e.g., transmitted in a beacon, a probe response, etc.) but may use different elements (or in some embodiments, may use the same element to provide the information). In some embodiments, the message 110B may be transmitted in a separate frame than the message 110A. In some embodiments, the message 110B may be transmitted sometime after the start of transmission of message 110A. As a result, the messages 110A and 110B effectively indicate when the access point 102 will become unavailable and for how long the access point 102 will remain unavailable. When the device 104 receives the messages 110A or 110B, the device 104 will be informed of the time when the access point 102 will be unavailable, and the device 104 may avoid transmitting to the access point 102 during that time and not reduce its MCS rate used with the access point. For example, the device 104 may buffer messages for transmission during that time and transmit the buffered messages when the access point 102 becomes available.

After the access point 102 has expanded the bandwidth 106 to the expanded bandwidth 108, and the access point 102 becomes available again, then the access point 102 may communicate (e.g., broadcast) a message 112 indicating that the access point 102 has completed expanding the bandwidth 106 and that the access point 102 is available. After the device 104 receives the message 112, the device 104 may resume transmitting to the access point 102. In some instances, the access point 102 may finish expanding the bandwidth 106 earlier or sooner than indicated in the message 110A or 110B. Thus, transmitting the message 112 may allow the access point 102 and the device 104 to resume communications sooner than anticipated.

At a later time, the access point 102 may determine that the expanded bandwidth 108 is no longer needed (e.g., because the traffic at the access point 102 has reduced and the access point 102 does not need most or all of the expanded bandwidth 108). In response, the access point 102 may determine that the expanded bandwidth 108 should be reduced or reset to the previous unexpanded bandwidth 106. The access point 102 may communicate (e.g., transmit in a beacon, a probe response, etc.) a message 114A indicating a future time when the access point 102 will reduce or reset the expanded bandwidth 108. The access point 102 may also communicate (e.g., in a beacon, a probe response, etc.) a message 114B that indicates an amount of time it will take for the access point 102 to reduce or reset the expanded bandwidth 108 to the bandwidth 106 (or another bandwidth value). In some embodiments, the message 114B may be transmitted in a separate frame than the message 114A. In some embodiments, the message 114B may be transmitted sometime after the start of transmission of message 114A. In some embodiments, the access point 102 may also communicate the messages 114A and 114B when the access point 102 determines to change its expanded bandwidth 108 to another expanded bandwidth value (instead of resetting the bandwidth) where messages indicate similar timing parameters as described above. As a result, the messages 114A and 114B effectively indicate when the access point 102 will become unavailable and for how long the access point 102 will remain unavailable for a bandwidth change. When the device 104 receives the message 114A or 114B, the device 104 will be informed of the time when the access point 102 will be unavailable, and the device 104 may avoid transmitting to the access point 102 during that time. For example, the device 104 may buffer messages for transmission during that time and transmit the buffered messages when the access point 102 becomes available.

In some embodiments, when the access point 102 finishes reducing or resetting the expanded bandwidth 108 or changing its expanded bandwidth to another expanded bandwidth value, the access point 102 may transmit (e.g., broadcast) a message similar to message 112 indicating that the access point 102 has finished reducing or resetting or changing the expanded bandwidth 108 and that the access point 102 is available. After the device 104 receives that message, the device 104 may resume transmitting to the access point 102. In some instances, the access point 102 may finish reducing, resetting, or changing the expanded bandwidth 108 earlier or sooner than indicated in the message 114A or 114B. Thus, transmitting the message similar to the message 112 may allow the access point 102 and the device 104 to resume communications sooner than anticipated.

FIG. 1B illustrates an example access point 102 or device 104 in the system of FIG. 1A. As seen in FIG. 1B, the access point 102 or device 104 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), or state machines, that communicatively couples to the memory 124 and controls the operation of the access point 102 or device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 or device 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 or device 104 may use one or more of the radios 126 for Wi-Fi communications. The access point 102 or device 104 may use one or more of the radios 126 to transmit messages and one or more of the radios 126 to receive messages. The access point 102 or device 104 may include any number of radios 126 to communicate using any number of communication technologies.

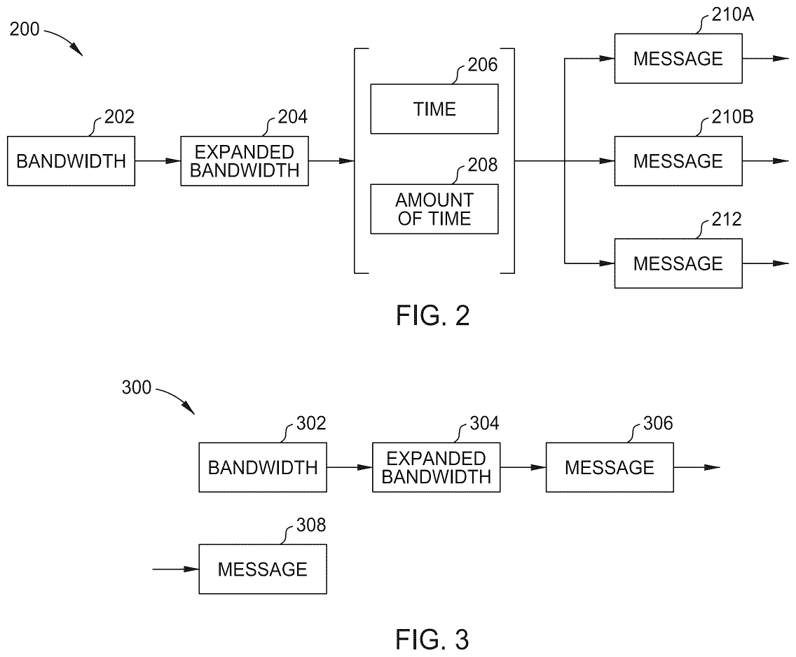

FIG. 2 illustrates an example operation 200 performed by the system 100 of FIG. 1A. Generally, an access point (e.g., the access point 102 shown in FIG. 1A) may perform the operation 200. By performing the operation 200, the access point may signal when and for how long the access point will be unavailable to perform bandwidth expansion.

The access point begins by determining that a bandwidth 202 of the access point should be expanded to an expanded bandwidth 204. For example, the access point may experience increased traffic (e.g., due to virtual reality applications, videoconferencing applications, or other high throughput applications) that may cause the access point to reach traffic limits imposed by the bandwidth 202. In response, the access point may determine that the bandwidth 202 should be expanded to the expanded bandwidth 204. For example, the access point may determine to expand its bandwidth from 40 MHz to 160 MHz to serve increased traffic demand at the access point from one or more devices.

The access point may determine a time 206 in the future when the access point will expand the bandwidth 202 to the expanded bandwidth 204. Additionally, the access point may determine an amount of time 208 that it will take for the access point to expand the bandwidth 202 to the expanded bandwidth 204 when bandwidth expansion is performed at time 206. The access point may be unavailable to serve the devices for the amount of time 208 starting from time 206. In some instances, the amount of time 208 may include a bandwidth switching delay of the access point and may be in the range of 10 milliseconds (msecs) to 500 msecs (e.g., 10 msecs, 20 msecs, 30 msecs, 50 msecs, 100 msecs, 200 msecs, 500 msecs, etc.). Other values are possible for the amount of time 208. Different access point implementations may have different bandwidth switching delays when changing bandwidths. At the access point, similar bandwidth switching delays may apply for the access point to expand its bandwidth or reduce its bandwidth or reset its bandwidth or in general change to another bandwidth value.

The access point may then generate and communicate (e.g., broadcast) a message 210A that indicates the time 206 (e.g., transmit the message 210A in a beacon, a probe response, etc. using UHR critical update mechanism which indicates bandwidth expansion as a critical BSS parameters update and indicates the time 206 as the time when the bandwidth expansion takes effect).

Then, the access point may transmit another message 210B that indicates the amount of time 208 for which the access point will be unavailable to perform bandwidth expansion starting at time 206. The message 210B may be any type of message (e.g., a maximum bandwidth switch time indicated in a beacon, probe response etc., a quiet element, a clear-to-send to self (CTS-to-self), or a scheduled link disablement message using advertised TID-to-link mapping (TTLM) (which may be applicable and understood by extremely high throughput (EHT) client devices)), that is sent to devices to signal that the access point is unavailable to serve the devices during the amount of time 208. Depending upon the type of the message 210B, the message 210B may be sent far in advance of time 206 or may be sent before time 206, as described below for each type of the message 210B.

When the message 210B includes a maximum bandwidth switch time to signal the amount of time 208 that the access point is unavailable to serve the devices, then the access point may transmit a maximum bandwidth switch time field in an element (e.g., in a UHR Operation element, a UHR Parameters Update element, a DBE related element, or another element) in the beacon, probe response, etc. Then, the messages 210A and 210B are both transmitted in a beacon, probe response, etc. The devices then will not transmit to the access point for the duration indicated by the maximum bandwidth switch time field starting at time 206 (unless another frame is received earlier than that time from the access point, which indicates a faster bandwidth switch at the access point). This approach may apply for UHR devices that understand the new field and may not apply for legacy devices that may not understand the new maximum bandwidth switch time field.

When a quiet element is used for the message 210B, then the access point transmits a quiet element in a beacon, probe response, (re)association response, etc., where the fields are set as follows:
Quiet Count field: which indicates the number of TBTTs until the next quiet interval starts, is set based on the time 206.
Quite Duration field: which indicates the duration of the quiet period (in Time Units (TU)), is set based on the time 208.

The quiet element notifies the device about a quiet period (indicated by the Quite Duration field) during which the device should not transmit to the access point. The quiet element may be sent in advance (and repeated in multiple beacon frames) and schedules a quiet period starting at (or close to) the time 206. In this manner, devices do not transmit to the access point when the access point is unavailable for changing its bandwidth starting at time 206.

When a CTS-to-self is used for the message 210B, the access points transmits a CTS-to-self frame where the Duration field is set based on the amount of time 208, indicating that the wireless medium is reserved for the indicated duration time. As a result, the devices will not transmit to the access point during the indicated time duration. The CTS-to-self message is sent by the access point before the time 206 to indicate that the wireless medium is occupied for the bandwidth switch time. The CTS-to-self message is not sent too far in advance of the time 206.

When the access point uses the scheduled link disablement using advertised TTLM for message 210B, the access point sends an advertised TTLM element in a beacon, probe response, etc. to indicate that the link where bandwidth expansion is happening is disabled for a time duration starting at (or close to) the time 206 and for the amount of time 208 (or close to that amount of time). The scheduled link disablement using advertised TTLM can be sent in advance in a beacon, probe response, etc. Then, because the link is indicated as disabled, devices will not transmit to the access point during the time duration indicated.

Devices that receive the messages 210A and 210B may then be informed of when the access point will be unavailable to expand the bandwidth 202 to the expanded bandwidth 204. The devices may then avoid transmitting to the access point during that time.

In some embodiments, the access point may communicate multiple messages of different types to indicate the amount of time 208 for which the access point will be unavailable for performing bandwidth expansion at time 206. For example, the access point may generate and communicate a message 212 that also indicates the amount of time 208. The message 212 may be a different type than the message 210B. For example, if the message 210B is a quiet element, then the message 212 may be a CTS-to-self or a scheduled link disablement using advertised TTLM for bandwidth switch time. By transmitting different message types to indicate the amount of time 208, the access point may increase the number of devices that are informed of the amount of time 208. For example, if a quiet element is not understood or followed by all devices, then sending a message 212 that indicates a CTS-to-self may be understood by most devices. The time duration indicated in each of these messages may be set slightly differently but still based on the bandwidth switch time of the access point to change its bandwidth.

The access point may provide, to the device, an average or worst-case amount of time to expand the bandwidth (e.g., when announcing the bandwidth expansion in a beacon or probe response, if any). This is described above by the option described for 210B where the access point provides a maximum bandwidth switch time to signal the amount of time 208. In some instances, the access point may expand the bandwidth a bit faster in many cases than the maximum bandwidth switch time indicated. If the access point uses a quiet element, or CTS-to-self or a scheduled link disablement using advertised TTLM, the access point may or may not set the duration indicated in these signaling to equal the maximum bandwidth switch time announced in the beacon or probe response. In some embodiments, the access point may not announce any maximum bandwidth switch time to the devices and instead uses the one or more of the signaling mechanism described for indicating the amount of time 208.

The procedure describe above where the access point indicates the amount of time 208 to the devices using one or more of i) a quiet element, ii) a CTS-to-self, or iii) a scheduled link disablement using advertised time to TTLM, may be used by the access point for any bandwidth change, which includes expanding, reducing, resetting or in general changing the bandwidth to another bandwidth value.

FIG. 3 illustrates an example operation 300 performed by the system 100 of FIG. 1A. Generally, an access point (e.g., the access point 102 shown in FIG. 1A) may perform the operation 200. By performing the operation 200, the access point expands bandwidth and signals the completion of bandwidth expansion.

The access point begins by expanding a bandwidth 302 of the access point to an expanded bandwidth 304. For example, the access point may have previously signaled that the access point would expand the bandwidth 302 at a particular time. At that time, the access point may begin expanding the bandwidth 302 to the expanded bandwidth 304.

When the access point completes expanding the bandwidth 302 to the expanded bandwidth 304, the access point generates and communicates (e.g., broadcasts) a message 306 that indicates that the bandwidth 302 has been expanded to the expanded bandwidth 304. The message 306 may be a broadcast management frame, such as an unsolicited probe response frame, an announcement frame, a notification frame, etc. In a first example, the message 306 may be an unsolicited probe response frame that by default may indicate that the expanded bandwidth 304 is activated and that the access point is available for operation with the expanded bandwidth. In some embodiments, the unsolicited probe response frame may signal explicitly that the expanded bandwidth 304 is activated (e.g., by indicating enablement of dynamic bandwidth expansion (DBE) mode and indicating the expanded bandwidth (also referred to as the DBE bandwidth) in the unsolicited probe response). As a second example, the message 306 may be a dynamic bandwidth switch announcement frame or operating mode notification frame which the access point transmits to a broadcast address to announce the completion of bandwidth expansion and indicates the expanded bandwidth. In this manner, the access point alerts devices that the access point is available and using the expanded bandwidth 304. In some embodiments, this procedure of sending the message 306 for notifying devices that access point is available and has completed its bandwidth change may be used for any bandwidth change, which includes expanding, reducing, resetting or in general, changing the bandwidth to another bandwidth value.

For DBE, the bandwidth expansion is done for a longer time scale such as for minutes (e.g., 1 minute, 2 minutes, 5 minutes, 10 minutes, 20 minutes, 30 minutes, etc.). For DBE, the first example using an unsolicited probe response may be preferred because it provides a simple solution to notify devices of completion of bandwidth expansion using an existing frame.

If the access point had previously sent a CTS-to-self to signal the bandwidth expansion and the bandwidth expansion is completed before the CTS-to-self duration expires, then the access point may send a contention-free end (CF-end) frame to notify devices of the end of the medium being occupied before the access point sends out the message 306. In this manner, the access point may cause the devices to listen to receive the message 306.

The access point may then receive a message 308 using the expanded bandwidth 304. For example, the message 308 may be communicated by a device to the access point after the access point has completed expanding the bandwidth 302 to the expanded bandwidth 304. The device may use the expanded bandwidth to communicate the message 308 to the access point (e.g., message 308 may be a data frame communicated using the expanded bandwidth 304), which may provide increased data capacity due to the expanded bandwidth 304. For example, after the bandwidth 302 has been expanded to the expanded bandwidth 304, the access point and the devices may operate with the expanded bandwidth 304. The access point and the devices may begin transmissions following enhanced distributed channel access (EDCA) and triggered uplink access (TUA) procedures using the expanded bandwidth 304. Given this bandwidth expansion is not a per transmission opportunity (TxOP) level operation, this procedure where the access point and the device have the flexibility to transmit using EDCA or TUA (using multi-user enhanced distributed channel access (MU-EDCA)) may be the preferred operation mode. The access point and device may account for the bandwidth switching delay of other devices and may not transmit to the other devices before the switching delay has elapsed.

In some embodiments, a device does not start a transmission until the device hears first from the access point (either a broadcast or individually addressed frame). In this case, the access point may send a broadcast frame (e.g., unsolicited Probe Response frame) after bandwidth expansion (or any bandwidth change) is completed. The device may listen for an unsolicited Probe Response frame from the access point, a beacon frame, or another frame from the access point before the device starts transmission to the access point after the DBE bandwidth change operation.

Because this bandwidth expansion is not a TXOP level change, no initial control frame/initial control response frame (ICF/ICR) exchange may be performed after bandwidth expansion. In some instances, however, an ICF (e.g., multi-user request to send (MU-RTS) frame or a buffer status report poll (BSRP) Trigger frame) sent by the access point to a broadcast address may be a signal for devices in the BSS to know that the access point is available after the bandwidth expansion.

In some embodiments, the access point starts the first exchange after the bandwidth expansion, which could be a broadcast frame sent to devices (e.g. unsolicited probe response) or ICF for initiating transmit/receive with some in-BSS devices.

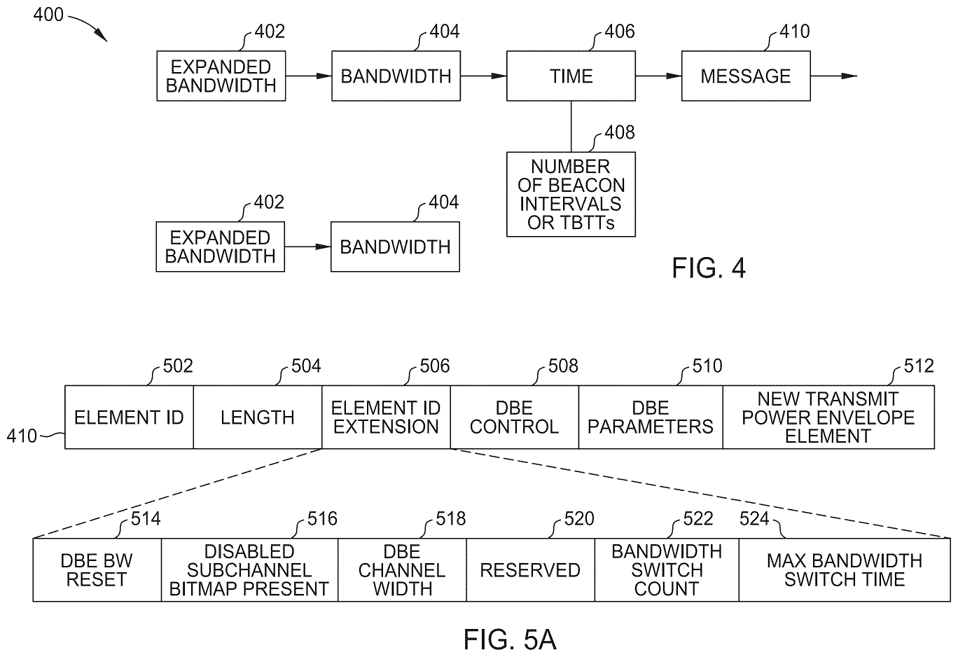

FIG. 4 illustrates an example operation 400 performed by the system 100 of FIG. 1A. Generally, an access point (e.g., the access point 102 shown in FIG. 1A) may perform the operation 400. By performing the operation 400, may reduce or reset an expanded bandwidth.

The access point begins by determining that an expanded bandwidth 402 should be reduced or reset to a bandwidth 404. For example, the access point may determine that the traffic at the access point has reduced and that the expanded bandwidth 402 is no longer needed to handle that traffic level. In response, the access point may determine that the expanded bandwidth 402 should be reduced or reset to the bandwidth 404.

The access point determines a time 406 when the expanded bandwidth 402 should be reduced or reset to the bandwidth 404. In some instances, the access point determines or expresses the time 406 as a number of beacon intervals from the current time or number of TBTTs 408 (until the TBTT when the bandwidth is reduced or reset or changed). The access point then generates and communicates (e.g., broadcasts) a message 410 to indicate the time 406. The devices that receive the message 410 may be informed of the time 406 when (or the number of beacon intervals or number of TBTTs 408 until) the access point reduces or resets the expanded bandwidth 402 to the bandwidth 404. In this manner, the access point may signal to the devices when the access point will be unavailable to reduce or reset the expanded bandwidth 402.

In a first option, the message 410 may be an announcement element (e.g., in a beacon, probe response, etc.), which indicates that the bandwidth is being set to the BSS operating bandwidth in a certain number of indicated beacon intervals or number of TBTTs 408. After that many beacon intervals or number of TBTTs 408, the expanded bandwidth operation terminates and the expanded bandwidth 402 is reset to the BSS operating bandwidth 404.

In a second option, the access point signals that the expanded bandwidth 402 is being reset in a ultra-high reliability (UHR) operation element without including another bandwidth expansion announcement element to optimize on size. In this case, the DBE bandwidth reset count and maximum bandwidth switch delay (to reset the bandwidth) may be provided in the UHR operation element.

At the time 406 (or after the number of beacon intervals or number of TBTTs 408), the access point may reduce or reset the expanded bandwidth 402 to the bandwidth 404. The access point may be unavailable when the access point is reducing or resetting the expanded bandwidth 402. The devices may refrain from transmitting to the access point during this time. The access point may notify the devices about its unavailability using any of the mechanisms as described for indicating the time 208 above in FIG. 2.

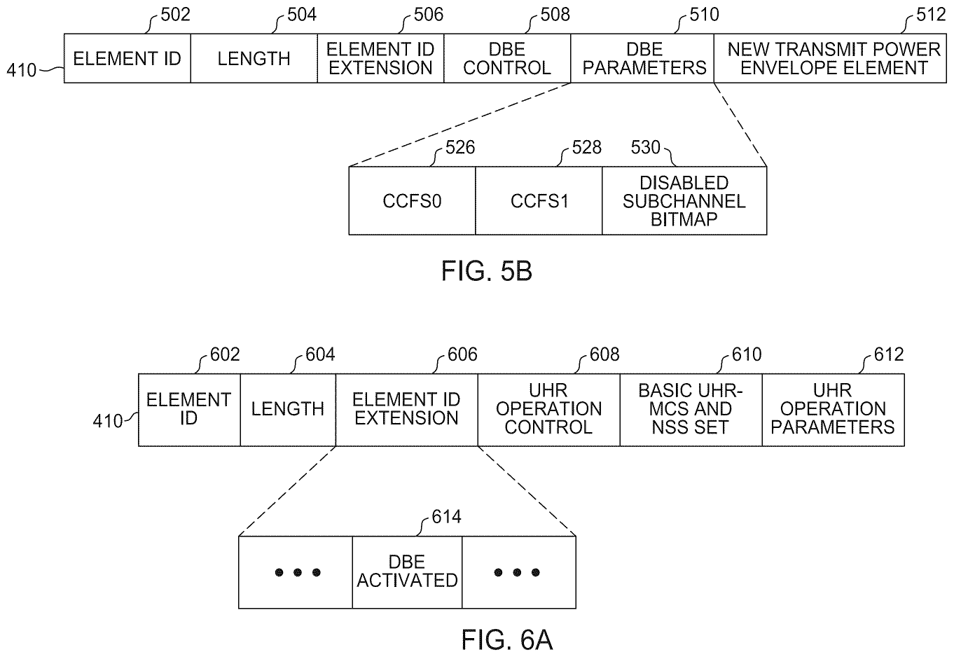

FIGS. 5A and 5B illustrate an example message 410 in the system 100 of FIG. 1A. Generally, the access point may generate and communicate (e.g., broadcast in a beacon, probe response, etc.) the message 410 to signal when the access point will reduce or reset an expanded bandwidth. In the example of FIGS. 5A and 5B, the message 410 may be a beacon, probe response, etc. (as explained above as the first option).

As seen in FIG. 5A, the message 410 includes fields 502, 504, 506, 508, 510, and 512. The field 502 includes an element identifier. The field 504 indicates a length. The field 506 includes an element identifier extension. The field 508 indicates a dynamic bandwidth expansion (DBE) control. The field 510 indicates DBE parameters. The field 512 includes a new transmit power envelope element.

The field 506 includes fields 514, 516, 518, 520, 522, and 524. The field 514 indicates whether the DBE bandwidth is being reset (e.g., set to 1 to indicate reset to the BSS bandwidth). The field 516 indicates whether a disabled subchannel bitmap is present. The field 518 indicates a DBE channel width (or DBE bandwidth e.g., set to the bandwidth after the reset). The field 520 may be reserved for future use. The field 522 may indicate a number of target beacon transmission time (TBTT) (or beacon intervals) before the bandwidth is reset or before the expanded bandwidth is terminated. The field 524 may indicate a maximum amount of time taken for the bandwidth to be reset.

As seen in FIG. 5B, the field 510 includes field 526, 528, and 530. The field 526 indicates a channel center frequency segment 0(CCFS0), and the field 528 indicates a channel center frequency segment 1 (CCFS1). In another embodiment, two different CCFS0 and CCFS1 parameters may not be present and only a single CCFS parameter may be present to indicate the channel center frequency. In yet another embodiment, no explicit CCFS field(s) are indicated and the channel center frequency for the DBE channel width is indicated and derived from the DBE channel width field itself. The field 530 includes a disabled subchannel bitmap. In some instances, if the field 514 (shown in FIG. 5A) is set to 1, then the field 510, including the fields 526, 528, and 530 are not included in the message 410. In this case, the field 518 may be set to indicate the bandwidth value to which the bandwidth is being reset at the access point (e.g., the bandwidth 404).

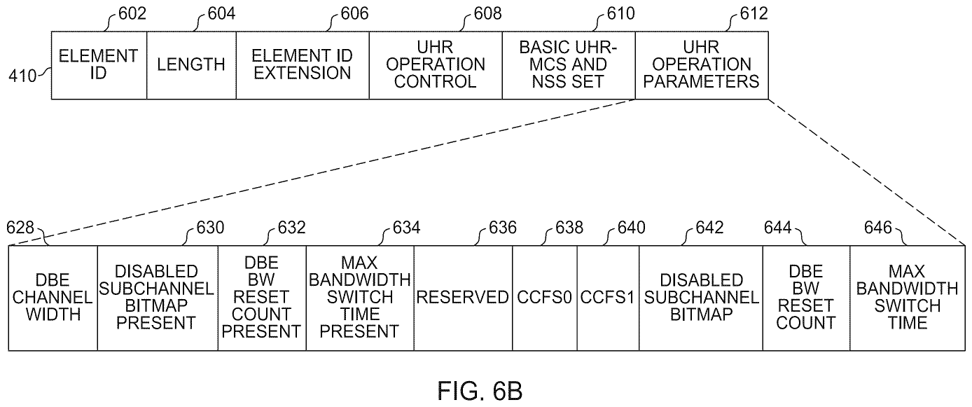

FIGS. 6A and 6B illustrate an example message 410 in the system 100 of FIG. 1A. Generally, the access point may generate and communicate (e.g., broadcast in a beacon, probe response, etc.) the message 410 to signal when the access point will reduce or reset an expanded bandwidth. In the example of FIGS. 6A and 6B, the message 410 may be a UHR operation element (as explained above as the second option). The access point may signal that the expanded bandwidth is being reset in the UHR operation element without including another DBE announcement, to optimize on signaling size in the beacon, probe response, etc. In this case, no separate DBE announcement element may be included. The DBE BW Reset Count and Max BW Switch Delay (to reset the bandwidth) may be provided in the UHR operation element. However, because this option modifies the UHR operation element dynamically, it may be a less preferred option.

As seen in FIG. 6A, the message 410 includes fields 602, 604, 606, 608, 610, 612, and 614. The field 602 includes an element identifier. The field 604 indicates a length. The field 606 includes an element identifier extension. The field 608 includes UHR operation control. The field 610 includes basic UHR modulation and coding scheme (UHR-MCS) and number of spatial streams (NSS) set. The field 612 includes UHR operation parameters.

The field 608 includes a field 614. The field 614 indicates whether DBE is activated (or DBE mode is enabled).

As seen in FIG. 6B, the field 612 includes fields 628, 630, 632, 634, 636, 638, 640, 642, 644, and 646. The field 628 indicates a DBE channel width (or DBE bandwidth). The field 630 indicates whether a disabled subchannel bitmap is present. The field 632 indicates whether a DBE bandwidth reset count is present. The field 634 indicates whether a maximum bandwidth switch count is present. The field 636 may be reserved for future use. The field 638 indicates a CCFS0, and the field 640 indicates a CCFS1. In one embodiment, the fields CCFS0 and CCFS1 may not be included (as described above). The field 642 includes a disabled subchannel bitmap. The field 644 includes a DBE bandwidth reset count, which may indicate a number of TBTTs (or beacon intervals) to the TBTT/time when the DBE bandwidth is reset (to the unexpanded BSS bandwidth) or when the expanded bandwidth is terminated. The field 646 may indicate a maximum bandwidth switch time indicating amount of time taken for the bandwidth to be reset.

Formats other than those shown in FIGS. 5A, 5B, 6A, and 6B are possible for elements, fields, subfields, and frames that include a similar set of content. The sizes of the fields or subfields may be different in terms of bits or octets.

DBE related elements, fields, or subfields may be carried in a frame that carries the overarching element where DBE elements, fields, or subfields are included (e.g., DBE bandwidth info may be included in a frame that carries the UHR Operation element). DBE announcement and DBE parameters (e.g., after DBE bandwidth expansion) may be carried in a beacon, probe response, (re)association response, or another management frame that is used to carry beacon or probe response level of information (e.g., a new beacon 2.0 or similar frame that may be introduced to address beacon bloating issues with legacy clients).

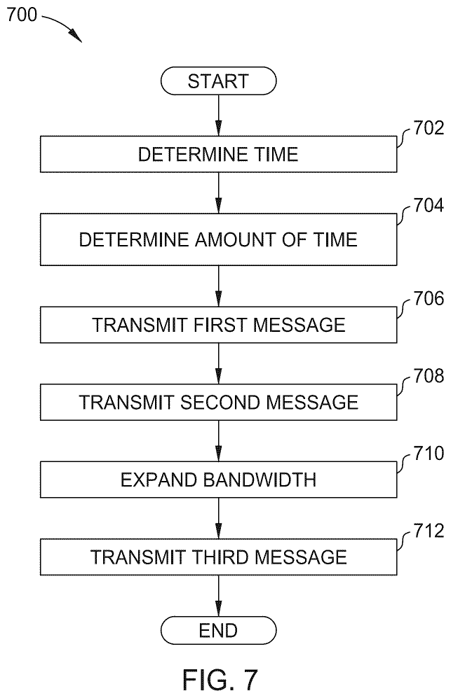

FIG. 7 is a flowchart of an example method 700 performed by the system 100 of FIG. 1A. In certain embodiments, an access point (e.g., the access point 102 shown in FIG. 1A) performs the method 700. By performing the method 700, the access point signals bandwidth expansion.

At 702, the access point determines a time when the access point will expand bandwidth. At 704, the access point determines an amount of time that the access point will take to expand the bandwidth.

At 706, the access point transmits a first message indicating the time at which the access point will expand bandwidth. For example, the access point may communicate a beacon or probe response to a device indicating when the access point will expand bandwidth. At 708, the access point transmits a second message indicating the amount of time. For example, the access point may communicate the amount of time in a beacon or probe response using a quiet element or a scheduled link disablement using advertised TTLM. In another example, the access point may send a CTS-to-self to indicating the amount of time.

At 708, when the access point reaches the time, the access point expands the bandwidth used by the access point. When the access point is expanding the bandwidth, the access point may be unavailable. Because the device was informed of when the access point would be expanding the bandwidth and the amount of time the access point will be unavailable, the device may avoid transmitting to the access point during that time.

At 712, after the access point has completed its bandwidth expansion and is available, the access point transmits a third message to indicate completion of bandwidth expansion and that the access point is ready to serve devices with expanded bandwidth.

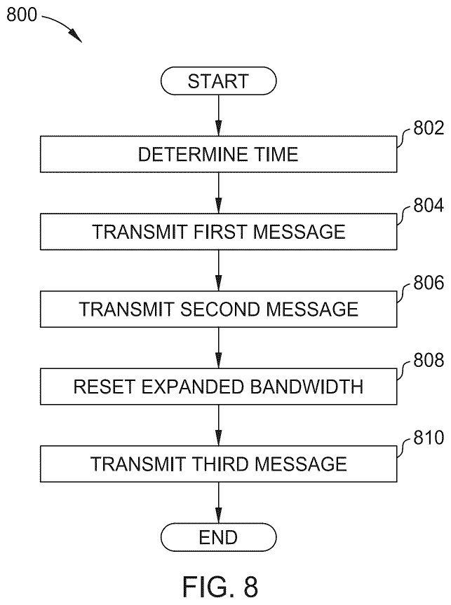

FIG. 8 is a flowchart of an example method 800 performed by the system 100 of FIG. 1A. In certain embodiments, an access point (e.g., the access point 102 shown in FIG. 1A) performs the method 800. By performing the method 800, the access point signals when bandwidth will be reduced or reset.

At 802, the access point determines a time when the access point will reduce or reset bandwidth. The access point may also determine an amount of time that the access point will take to reduce or reset the bandwidth. At 804, the access point transmits, to a device, a first message indicating the time. At 806, the access point transmits, to the device, a second message indicating the amount of time.

At 808, when the access point reaches the time, the access point reduces or resets the bandwidth used by the access point. When the access point is reducing or resetting the bandwidth, the access point may be unavailable. Because the device was informed of when the access point would be reducing or resetting the bandwidth, the device may avoid transmitting to the access point during that time. At 810, the access point transmits a third message indicating completion of the bandwidth reduction or reset and that the access point is ready to serve devices.

In some embodiments, the steps similar to those described in FIG. 7 and FIG. 8 may be used and apply when the access point changes its bandwidth dynamically using dynamic bandwidth expansion (DBE) operation from one expanded bandwidth to another expanded bandwidth (e.g., a change to the DBE bandwidth). For example, the access point may change its expanded bandwidth from an expanded bandwidth of 160 MHz to 320 MHz, or change its expanded bandwidth from an expanded bandwidth of 320 MHz to 160 MHz. This operation uses the same set of steps as FIG. 7 and FIG. 8. For example, the access point may transmit a first message to indicate a time when the DBE operation will begin. The access point may transmit a second message indicating an amount of time that the DBE operation will take. After the access point has completed the DBE operation starting at the time, the access point may transmit a third message indicating that the access point has completed the DBE operation and that the access point is ready to serve devices.

In summary, an access point 102 signals when the access point 102 changes bandwidth. For example, when the access point 102 determines that bandwidth should be expanded at a future time, the access point 102 may transmit messages to connected devices indicating the future time and an amount of time that the access point 102 will be unavailable during the bandwidth expansion (or bandwidth reset of bandwidth change). When the access point 102 completes expanding the bandwidth, the access point 102 may notify the devices that the bandwidth expansion is complete. As another example, when the access point 102 determines that the expanded bandwidth should be reset or reduced (e.g., to the original bandwidth) at another future time, the access point 102 may transmit messages to the connected devices indicating the future time and the amount of time it will take to reset or reduce the expanded bandwidth. In this manner, the devices may be notified of when the access point 102 will be unavailable and avoid transmitting messages to the access point 102 during those times.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless access point comprising:
one or more memories; and
one or more processors communicatively coupled to the one or more memories, the one or more processors configured to, individually or collectively, perform an operation comprising:
based on determining that a bandwidth of a channel should be expanded to an expanded bandwidth, determining (i) a first time when the wireless access point will begin expanding the bandwidth and (ii) an amount of time the wireless access point will use to expand the bandwidth starting at the first time;
transmitting, before the first time, a first message indicating the first time;
transmitting, before the first time, a second message indicating the amount of time; and
at the first time, expanding the bandwidth of the channel.

2. The wireless access point of claim 1, wherein the operation further comprises transmitting a third message different from the second message indicating the amount of time.

3. The wireless access point of claim 2, wherein the second message or the third message is at least one of a maximum bandwidth switch time, a quiet element, a clear to send to self (CTS-to-self), or a link disablement using advertised TID-to-link mapping (TTLM).

4. The wireless access point of claim 1, wherein the first message is transmitted in a beacon or a probe response frame.

5. The wireless access point of claim 1, wherein the operation further comprises, after the bandwidth has been expanded to the expanded bandwidth, transmitting a third message indicating that the bandwidth has expanded to the expanded bandwidth.

6. The wireless access point of claim 5, wherein the third message is at least one of an unsolicited probe response frame, an announcement frame, or a notification frame.

7. The wireless access point of claim 5, wherein the operation further comprises receiving a message using the expanded bandwidth.

8. The wireless access point of claim 1, wherein the operation further comprises:
based on determining that the expanded bandwidth should be reset to the bandwidth, determining a second time when the wireless access point should begin resetting the expanded bandwidth;
transmitting a third message indicating the second time;
transmitting a fourth message indicating a second amount of time that the wireless access point will use to reset the bandwidth; and
at the second time, resetting the expanded bandwidth to the bandwidth.

9. The wireless access point of claim 8, wherein the operation further comprises transmitting a fifth message different from the fourth message indicating the second amount of time.

10. The wireless access point of claim 8, wherein the operation further comprises, after the expanded bandwidth is reset to the bandwidth, transmitting a fifth message indicating that the bandwidth is reset.

11. The wireless access point of claim 8, wherein the first time or the second time is expressed as a number of beacon intervals or number of TBTTs.

12. A method comprising:
based on determining that a bandwidth of a channel should be expanded to an expanded bandwidth, determining, by a wireless access point, (i) a first time when the wireless access point will begin expanding the bandwidth and (ii) an amount of time the wireless access point will use to expand the bandwidth starting at the first time;
transmitting, by the wireless access point and before the first time, a first message indicating the first time;
transmitting, by the wireless access point and before the first time, a second message indicating the amount of time; and
at the first time, expanding the bandwidth of the channel.

13. The method of claim 12, further comprising transmitting a third message different from the second message indicating the amount of time.

14. The method of claim 13, wherein the second message or the third message is at least one of a maximum bandwidth switch time, a quiet element, a clear to send to self (CTS-to-self), or a link disablement using advertised TID-to-link mapping (TTLM).

15. The method of claim 12, wherein the first message is transmitted in a beacon or a probe response frame.

16. The method of claim 12, further comprising, after the bandwidth has been expanded to the expanded bandwidth, transmitting a third message indicating that the bandwidth has expanded to the expanded bandwidth.

17. The method of claim 16, wherein the third message is at least one of an unsolicited probe response frame, an announcement frame, or a notification frame.

18. The method of claim 16, further comprising receiving a message using the expanded bandwidth.

19. The method of claim 12, further comprising:
based on determining that the expanded bandwidth should be reset to the bandwidth, determining a second time when the wireless access point should begin resetting the expanded bandwidth;
transmitting a third message indicating the second time;
transmitting a fourth message indicating a second amount of time that the wireless access point will use to reset the bandwidth; and
at the second time, resetting the expanded bandwidth to the bandwidth.

20. A device comprising:
one or more memories; and
one or more processors communicatively coupled to the one or more memories, the one or more processors configured to, individually or collectively, perform an operation comprising:
receiving, from a wireless access point, a first message indicating a first time when the wireless access point will begin expanding a bandwidth of a channel to an expanded bandwidth;
receiving, from the wireless access point, a second message indicating an amount of time the wireless access point will use to expand the bandwidth starting at the first time; and
at the first time, refrain from transmitting a message to the wireless access point for the amount of time.
